(19) United States
(12) Patent Application Publication
(10) Pub. No.: US 2007/0080624 A1
(43) Pub. Date: Apr. 12, 2007

(54) DISPLAY DEVICE

(76) Inventors: Kaoru Koiwa, Tokyo (JP); Miki Mori, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/609,917

(22) Filed: Dec. 13, 2006

Related U.S. Application Data
(63) Continuation of application No. PCT/JP05/13828, filed on Jul. 28, 2005.

(30) Foreign Application Priority Data
Jul. 30, 2004 (JP) 2004-224690

(51) Int. Cl. H01J 63/04

(52) U.S. Cl. 313/495; 313/496; 313/497

(57) ABSTRACT

A display device comprises a rear substrate which has a plurality of electron emission elements, a front substrate which has a display surface, is arranged opposite to the rear substrate by a gap interposed and has a plurality of fluorescent layers that correspond to the electron emission elements, and a transparent conductive layer which is arranged on the display surface of the front substrate and is connected to the ground.

### CROSS REFERENCE TO RELATED APPLICATIONS

This is a Continuation Application of PCT Application No. PCT/JP2005/013828, filed Jul. 28, 2005, which was published under PCT Article 21(2) in Japanese.

This application is based upon and claims the benefit of priority from prior Japanese Patent Application No. 2004-224690, filed Jul. 30, 2004, the entire contents of which are incorporated herein by reference.

### BACKGROUND OF THE INVENTION

1. Field of the Invention

The present invention relates to a display device having a vacuum envelope formed by fusing a rear substrate and a front substrate at their peripheral edges, the rear substrate having a plurality of electron emission elements and the front substrate having a plurality of fluorescent layers.

2. Description of the Related Art

In recent years, image display devices of various types have been developed as next-generation, thin and light display devices to take place of cathode-ray tubes (hereinafter referred to as CRTs). The image display devices include liquid crystal displays (hereinafter referred to as LCDs), plasma display panels (hereinafter referred to as PDPs), field-emission displays (hereinafter referred to as FEDs), and surface-conduction electron-emitter displays (hereinafter referred to as an SEDs). In the LCD, the intensity of light is controlled by utilizing the alignment of liquid crystal molecule. In the PDP, ultraviolet rays generated by plasma discharge excite a fluorescent member, which emits light. In the FED, electron emission elements emit electron beams, which cause a fluorescent member to emit light. In the SED, surface-conduction electron-emitter elements emit electron beams to cause a fluorescent member to emit light.

FEDs and SEDs have, in most cases, a front substrate and a rear substrate. The substrates arranged opposite to each other, with a predetermined gap between them. The substrates are bonded to each other, at their peripheries, with a rectangular frame-shaped sidewall interposed between them, providing a vacuum envelope. A fluorescent screen having is formed on the inner surface of the front substrate. On the inner surface of the rear substrate, a number of electron emission elements are arranged and used as sources of electrons. Electrons emitted from these elements excites the fluorescent members, making them emit light.

To support the front and rear substrates against the atmospheric pressure applied to them, a plurality of support members are provided between the substrates. The rear substrate is set at a potential that is almost the ground potential. An anode voltage Va is applied to the fluorescent screen. The electron beams emitted from the electron emission elements are applied to the red, green and blue fluorescent members constituting the fluorescent screen, whereby an image is displayed, as disclosed in, for example, Jpn. Pat. Appln. KOKAI Publication No. 2003-16937.

In the surface of the FED or SED described above, i.e., the surface of the front substrate may be electrically charged in some cases. If the surface is electrically charged, discharge may take place between the rear substrate and the front substrate. If this occurs, any part of the display screen where discharge has occurred appears white, impairing the quality of the image displayed. To suppress the discharge at the surface of the front substrate, a copper tape may be bonded to the peripheral edge of the front substrate and may be connected to the ground. This is because peripheral edge of the front substrate impose no influence on the image quality. The tape can indeed remove an electrical charge from those parts of the front substrate, which lie near the peripheral edge of the front substrate, but cannot remove an electrical charge from the center part of the front substrate. The display defect remains at the center of the display screen.

### BRIEF SUMMARY OF THE INVENTION

The present invention has been made in light of the above. An object of the invention is to provide a display device that can display high-quality images.

A display device according to an aspect of this invention comprises:

a rear substrate which has a plurality of electron emission elements;

a front substrate which has a display surface, is arranged opposite to the rear substrate by a gap interposed and has a plurality of fluorescent layers that correspond to the electron emission elements; and

a transparent conductive layer which is arranged on the display surface of the front substrate and is connected to the ground.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an FED according to a first embodiment of the present invention;

FIG. 2 is a sectional view taken along line II-II shown in FIG. 1;

FIG. 3 is a sectional view of a conductive film shown in FIGS. 1 and 2;

FIG. 4 is a sectional view of an FED, showing a modification of the conductive film shown in FIGS. 1 and 2; and

FIG. 5 is a sectional view showing an FED according to a second embodiment of the present invention.

### DETAILED DESCRIPTION OF THE INVENTION

An FED according to a first embodiment of this invention will be described in detail, with reference to the accompanying drawings.

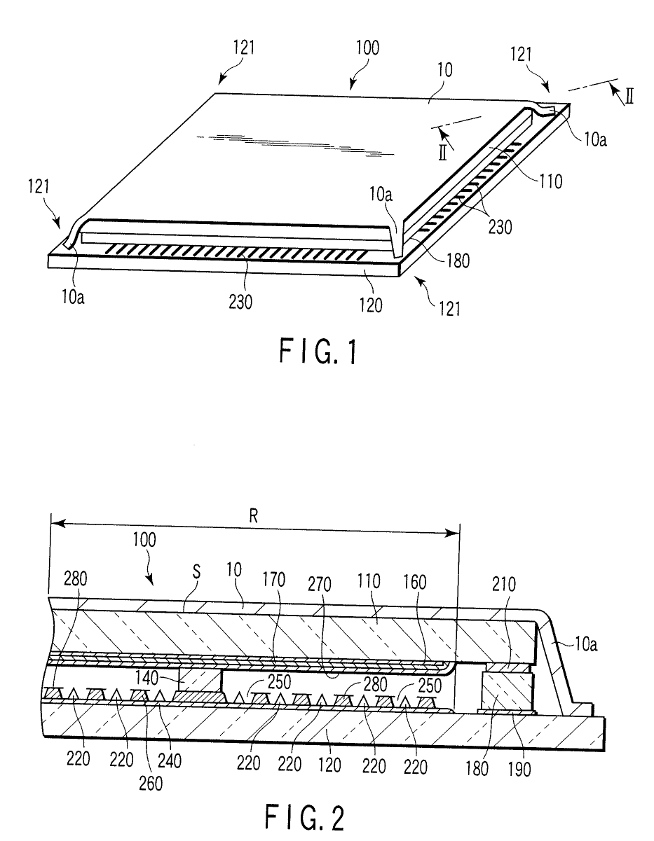

As shown in FIGS. 1 and 2, the FED comprises a front substrate 110 and rear substrate 120, which are rectangular glass plates. The substrates are arranged opposite to each other, by a predetermined gap between them. The rear substrate 120 is larger than the front substrate 110. The front substrate 110 and the rear substrate 120 are bonded, at their peripheries, via a rectangular frame-shaped sidewall 180 interposed between them, providing a rectangular flat vacuum envelope 100, in which a high vacuum is maintained.

In the vacuum envelope 100, a plurality of plate-like support members 140 (only some are shown) are provided, supporting the front substrate 110 and substrate 120, so that the substrates 110 and 120 may withstand the atmospheric pressure applied to them. The support members 140 extend parallel to one side of the vacuum envelope 100. The members 140 are arranged in a direction intersecting at right angles with that side of the vacuum envelope 100 and spaced apart at predetermined intervals. The members 140 are not limited to plate-like ones. Instead, they may be columnar ones.

The front substrate 110 and the rear substrate 120 have a rectangular display region R each, at the center part. A fluorescent screen 160 is provided on the inner surface of the front substrate. More precisely, it is provided in the display region R. The fluorescent screen 160 comprises fluorescent layers of red, blue and green (not shown) and light-shielding layers arranged between the fluorescent layers. On the fluorescent screen 160, a metal-back layer 170 and a getter film 270 are laid, one on the other.

In the display region R, a plurality of electron emission elements 220 are provided on the inner surface of the rear substrate 120. The elements 220 are sources of electrons and emit electron beams, which will excite the fluorescent layers of the fluorescent screen 160. The electron emission elements 220 are arranged in rows and columns, each provided for one pixel (composed of a plurality of fluorescent layers). More specifically, conductive cathode layers 240 are formed on the inner surface of the rear substrate 120, and a silicon dioxide film 260 having a number of cavities 250 are formed on the conductive cathode layers 240. Gate electrodes 280 are formed on the silicon dioxide film 260. At the inner surface of the rear substrate 120, the electron emission elements 220, each shaped like a cone, are provided in the cavities 250. The conductive cathode layers 240 and the gate electrodes 280 are shaped like a stripe. The layers 340 intersect at right angles with the gate electrodes 280. A number of lines 230 are formed on the peripheral edge of the rear substrate 120, to apply potentials to the conductive cathode layers and gate electrodes.

In the FED configured as described above, a video signal is input to the electron emission elements 220 arranged in the form of a matrix and to the gate electrodes 280. Assume that electron emission elements 220 are at a reference potential. Then, a gate voltage of +100V is applied for the maximal luminance. To the fluorescent screen 160, +10 kV is applied. As a result, the electron emission elements 220 emit electron beams. The magnitudes of the electron beams emitted from the electron emission elements 220 are modulated with the voltages applied to the gate electrodes 280. The electron beams excite the fluorescent layers of the fluorescent screen 160. Thus excited, the fluorescent layers emit light, whereby an image is displayed.

Since high voltages are applied to the fluorescent screen 160, the front substrate 110, rear substrate 120, sidewall 180 and support members 140 are made of high-strain glass. The rear substrate 120 and the sidewall 180 are sealed to each other with low-melting glass 190 such as frit glass. The front substrate 110 and the sidewall 180 are sealed to each other with a sealing layer 210 made of electrically conductive, low-melting that contains indium (In).

A transparent conductive film 10 is laid on the surface S of the front substrate 110, which functions display surface. The surface S is a plane that includes at least the display region R. It may be the entire surface of the front substrate 110. The conductive film 10 has four conductive parts 10a that extend from the four corners of the film 10. The conductive parts 10a are connected to the corners of the rear substrate 120, respectively.

The conductive film 10 will be described in detail.

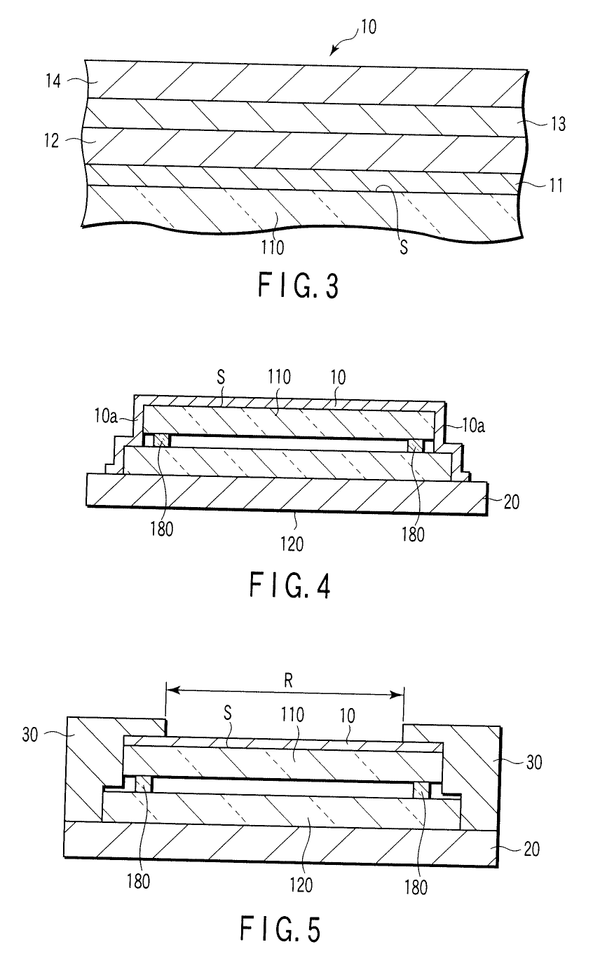

As FIG. 3 shows, the conductive film 10 has an adhesive film 11, a base film 12, a transparent resin-coat layer 13, and a conductive layer 14. The adhesive film 11 is made of, for example, glue. The base film 12 is made of transparent insulating material such as polyethylene terephthalate (PET), polyester, urethane, or the like. The resin-coat layer 13 functions as a reflection-preventing layer that suppresses reflection of externally applied light. The conductive layer 14 is made of transparent electrically conductive material such as indium tin oxide (ITO), SuO₂, TiO₂, ZnO₂, organic conductive material, or the like. The conductive layer 14 may contain at least one of the electrically materials specified above. The conductive layer 14 has surface resistance of 10³Ω to 10⁶Ω. In the present embodiment, its surface resistance is 10⁵Ω.

If the surface resistance of the conductive film 14 is less than 10³Ω, the conductive film 10 will be colored, inevitably reducing the brightness. If the surface resistance of the conductive film 14 exceeds 10⁶Ω, dust will stick to the surface of the conductive layer 14.

How the conductive film 10 is laid on the surface S of the front substrate 110 will be explained. First, the resin-coat layer 13 and the conductive layer 14 are formed, in the order mentioned, on the base film 12 that has been prepared. Then, the adhesive film 11 is formed on that surface of the front substrate 110, which faces away from the resin-coat layer 13. Thereafter, the base film 12 is bonded, with the adhesive film 11, to the surface S of the front substrate 110. The conductive film 10 is thereby laid on the surface S of the front substrate 110. At this point, the conductive parts 10a are bonded close to the corners 121 of the rear substrate 120 and electrically connected to the rear substrate. As indicated above, the conductive layer 14 is the most external layer of the conductive film 10. The layer 14 is electrically connected by the conductive parts 10a to the rear substrate 120 and is connected to the ground.

In the FED configured as described above, the conductive film 10 having the conductive layer 14 is arranged on the surface S of the front substrate 110. The conductive parts 10a formed by elongating the conductive film 10, at least in part, electrically connects the conductive layer 14 to the rear substrate 120. Hence, when the surface S is undesirably charged, the electric charge is applied to the rear substrate 120 through the conductive layer 14 and the conductive parts 10a. This prevents the surface S from being undesirably charged and ultimately suppresses undesirable discharge between the rear substrate 120 and the front substrate 110. In this embodiment, one conductive film 10 covers the surface S. Instead, strip-shaped conductive films may be arranged at regular intervals. The number of the conductive parts 10a that electrically connect the conductive layer 14 to the rear substrate 120 is not limited to four. Three or less conductive parts or five or more conductive parts may be used. Only if the conductive film 10 is elongated, at least in part, and is thereby connected to the ground, the above-mentioned advantage can be attained. The conductive parts 10a may be grounded at any other parts of the rear substrate 120 than the corners 121 thereof.

As FIG. 4 shows, the display device has a housing cover 20 that covers the reverse (outer) side of the rear substrate 120. The housing cover 20 is connected to the ground, and the conductive parts 10a are connected to the housing cover 20. Hence, the above-mentioned advantage can be attained. In the present embodiment, the conductive parts 10a have a stepped cross section each. The conductive parts 10a extend along the peripheral edges of the front and rear substrates 110 and 120. More precisely, the conductive parts 10a are formed, covering all peripheral edges of the front and rear substrates 110 and 120. Therefore, the conductive parts 10a can prevent glass chips from flying all over if the glass plates, i.e., the front substrate 110 and the like, are broken, and can protect the terminals formed on the peripheral edges of the rear substrate 120 against moisture.

The conductive film 10 used in this embodiment has the resin-coat layer 13 serving as a reflection-preventing layer for suppressing the reflection of light and provided between the base film 12 and the conductive layer 14. The conductive film 10 can suppress the reflection of any light externally applied, preventing the light from illuminating the display surface. The FED can therefore display images of higher quality than otherwise.

Thus, the invention can provide an FED that can display images of high quality.

An FED according to a second embodiment of this invention will be described in detail. The second embodiment is identical to the first embodiment, in respect of the structural features other than those described below. The components identical to those of the first embodiment are designated by the same reference numbers and will not be described in detail.

As FIG. 5 shows, this display device has a front frame 30 shaped like a picture frame, in addition to a front substrate 110, a rear substrate 120, a conductive film 10 and a housing cover 20. The film 10 is provided on the surface S of the front substrate. The housing cover 20 and the front frame 30 are connected to the ground.

The front frame 30 surrounds the peripheral edges of the front substrate 110 and rear substrate 120. The front frame 30 contacts a conductive layer 14 and rear substrate 120 and is secured to the housing cover 20. The front frame 30 is positioned, not overlapping the display region R. At least one part of the front frame 30 is made of electrically conductive material, connects the rear substrate 120 and conductive layer 14 to the ground and functions as a conductive part. In this embodiment, that part of the front frame 30, which contacts the conductive layer 14 and rear substrate 120 and electrically connects them, is made of electrically conductive material.

In the FED thus configured, the conductive film 10 having the conductive layer 14 is provided on the surface S of the front substrate 110. The front frame 30 has the function of electrically connecting the rear substrate 120 and the conductive film 14. If the surface S is undesirably charged, the electric charge can be expelled from the surface S to the rear substrate 120 through the conductive film 14 and the front frame 30. The surface S can therefore be prevented from having an undesirable electric charge. Thus, an undesirable discharge between the rear substrate 120 and the front substrate 110 can be suppressed. This advantage can be achieved even if the entire front substrate 30 is made of electrically conductive material. An electric charge, if any in the surface S, may be expelled to the housing cover 20 through the front frame 30. Hence, the FED can display images of high quality.

The front frame 30 can serve as a cover for a tape carriage package (TCP) (not shown). The FED is therefore easy to handle (to transport in the factory).

The present invention is not limited to the embodiments described above. Various changes can be made within the scope of the invention. For example, the conductive film 10 may be electrically connected to the rear substrate 120 or coupled to the housing cover 20 grounded, the front frame 30 or the like. The conductive film 10 may have an electromagnetic-wave shielding layer, instead of the resin-coat layer 13 that functions as a reflection-preventing layer. In this case, the electromagnetic-wave shielding layer is provided between the conductive layer 14 and the front substrate 110 may only need to shield electromagnetic waves, at least in part. The conductive layer 14 may be configured to function as such a reflection-preventing layer or electromagnetic-wave shielding layer as described above.

The conductive film 10 may have the function of preventing glass chips from flying all over if the glass plate constituting the front substrate or the like is broken.

The conductive layer 14 may be provided, not on the outermost layer of the conductive film 10, but on the side of the surface S and on any other layer of the conductive film, and may be connected to the ground. For example, the conductive layer 14 may be provided on the side of the adhesive film 11 and be bonded directly to the adhesive film. Then, the conductive layer can prevent glass chips from flying all around if implosion occurs in the FED. This can reduce the amount of dust that will stick to the conductive layer. Further, the conductive layer 14 may be formed by applying electrically conductive material to the surface S of the front substrate 110 and may then be connected to the ground. Then, glass chips can therefore be prevented from flying all over, and the amount of dust that may stick to the conductive layer can be reduced. In this case, a film functioning as a reflection-preventing layer, for example, is bonded to the conductive layer 14 that covers the surface S. An electromagnetic-wave shielding layer may be bonded to the conductive layer 14 that covers the surface S.

The conductive film 10 may have either the resin-coat layer 13 or an electromagnetic-wave shielding layer, or both.

The present invention is not limited to FEDs. It can be applied to SEDs.

What is claimed is:

1. A display device comprising:
a rear substrate which has a plurality of electron emission elements;
a front substrate which has a display surface, is arranged opposite to the rear substrate by a gap interposed and has a plurality of fluorescent layers that correspond to the electron emission elements; and
a transparent conductive layer which is arranged on the display surface of the front substrate and is connected to the ground.

2. A display device comprising:
a rear substrate which has a plurality of electron emission elements;
a front substrate which has a display surface, is arranged opposite to the rear substrate by a gap interposed and has a plurality of fluorescent layers that correspond to the electron emission elements; and
a conductive film which is arranged on the display surface of the front substrate and has a transparent conductive layer connected to the ground.

3. The display device according to claim 2, further comprising a conductive part that connects the conductive layer to the ground.

4. The display device according to claim 3, wherein the conductive part has been formed by elongating the conductive film, at least in part.

5. The display device according to claim 3, further comprising a frame part which surrounds peripheral edges of the rear substrate and front substrate and which functions as the conductive part.

6. The display device according to claim 5, wherein at least one part of the frame part is made of conductive material that connects the conductive layer to the ground.

7. The display device according to claim 2, wherein the conductive film includes a reflection-preventing layer that suppresses reflection of externally applied light.

8. The display device according to claim 2, wherein the conductive film includes an electromagnetic-wave shielding layer which shields electromagnetic waves, at least in part.

9. The display device according to claim 2, wherein the conductive film has a function of preventing chips from flying all over when the front substrate is broken into ships.

10. The display device according to claim 1, wherein the conductive layer contains at least one material selected from the group consisting of ITO, SuO₂, TiO₂, ZnO₂ and an organic conductive material.
